(19) United States
(12) Patent Application Publication
(10) Pub. No.: US 2003/0010870 A1
(43) Pub. Date: Jan. 16, 2003

(54) Space craft and methods for space travel

(76) Inventor: Charles M. Chafer, Houston, TX (US)

Correspondence Address: KILPATRICK STOCKTON LLP, 607 14TH STREET, N.W., SUITE 900, WASHINGTON, DC, 20005, US

(21) Appl. No.: 10/189,529

(22) Filed: Jul. 8, 2002

Related U.S. Application Data
(60) Provisional application No. 60/303,590, filed on Jul. 6, 2001.

(51) Int. Cl. B64G 1/42; B64G 1/40

(52) U.S. Cl. 244/172

(57) ABSTRACT

The present invention is directed to a space craft containing a sail craft capable of travel within and beyond the solar system. Propulsion for the sail craft is provided by a solar sail that reflects the light from the Sun to generate thrust. A carrier craft is also provided in the space craft to deploy and launch the sail craft. The space craft and missions involving the space craft include payloads and commercial advertising.

This application claims priority to Provisional Application No. 60/303,590, filed Jul. 6, 2001, the entire disclosure of which is hereby incorporated herein by reference.

### TECHNICAL AREA

The present invention is directed to space crafts and in particular to space crafts capable of travel outside of the solar system and into interstellar space.

### BACKGROUND

Traditionally, ships used for space travel, such as rockets and the space shuttle, have utilized chemical rocket engines to supply the thrust and acceleration needed to obtain and maintain earth orbit, moon landings, and interplanetary travel. Although rocket engines can produce very large amounts of force, the use of these chemical rocket engines imposes limitations on space travel due to fuel requirements.

Such limitations create a desire for alternative propulsion methods for space travel. Creative ideas for travel through space can be found at least as far back as the time of Johannes Kepler who envisioned sailing around the universe on the solar winds. Although such physical blowing “solar winds” do not exist, space crafts have been proposed for space travel that use a type of sail—a solar sail.

The theory behind the development of solar sails is based upon the fact that light may act as a particle that exerts a force upon the objects that it strikes. If a light particle, or photon, is actually reflected by the object, the exerted force is twice as large. For sunlight at a distance from the Sun of 1 Astronomical Unit (AU), that is at the distance from the Sun to the Earth, approximately 93 million miles, the force is about 9N/km².

In order to utilize this force, a solar sail would have to be made quite large, and its acceleration would be slow, but constant. Since no fuel is needed, most of the weight of the sail craft is devoted to the sail. The total weight of the sail craft is important, and minimizing mass per unit sail area is a key concern in sail craft design. If such constraints can be met, a sail craft could be constructed to transport a significant amount of payload, travel to the planets or the edge of the solar system in a reasonable period of time, and be controlled and steered in an effective and efficient manner.

### SUMMARY OF THE INVENTION

The present invention is directed to a space craft and methods of using the space craft whereby the space craft is launched into earth orbit and deploys a sail craft that sails throughout the solar system and into interstellar space. The space craft includes a sail craft and a carrier craft. The sail craft includes a solar sail capable of propelling the sail craft by reflecting light from the sun. The sail craft is attached to an extensible and rigidizable support structure so that the sail craft can be packaged for launch and unpackaged and deployed in space. The sail craft also includes avionics and a power array to provide the necessary power and control to the sail craft and a payload.

A conventional rocket launches the space craft as a secondary payload and places the space craft into a transfer orbit. The space craft includes a carrier craft that may have a rocket engine capable of propelling the space craft out of the initial transfer orbit. The carrier craft also includes a deployment and separation structure to deploy the sail craft and to start the sail craft on its voyage. The carrier craft also contains power supplies, controls, an imaging system, and communications system to capture and transmit to Earth images of the sail craft's deployment and initial voyage.

The space craft and missions utilizing the space craft can be combined with various commercial, research, and educational initiatives to generate revenue to offset the cost of construction and mission operation. These initiatives include advertising, information creation, transfer and presentation, and methods of interaction such as online contests.

The commercial possibilities for the space craft include fixation of advertising logos to the craft, having individual specific data, such as biological information, in the payload, and interactive contests. Logos that are placed on the sail craft, or space craft in general, can be viewed on Earth via cameras that are placed on the sail craft, carrier craft, a deployed free-flying camera platform, or launch vehicle. For cameras on the launching vehicle, the space craft and logos are typically filmed during launch and deployment of the craft. Once the sail craft is deployed, there will be times when it is visible from Earth. The sailcraft may also be photographed through earth-based telescopes during this period.

Contests can be created for use with a space craft mission. For example, there can be a contest to be the first person to find the sail craft in the sky. Such finding can be verified with a picture of the space craft, in outer space, from Earth. Prizes and rewards can be given to the winners. These rewards can include the ability to actually control the sail craft maneuvering from time to time. Other rewards can include public announcements of their accomplishment.

### BRIEF DESCRIPTION OF THE DRAWINGS

FIG. 1 is a plan view of the sail craft of the present invention;

FIG. 2 is a partial cross-section of the sail portion thereof;

FIG. 3 is a partial plan view of the sail showing the seams and rip terminators;

FIG. 4 is a partial perspective view of the support structure of the sail craft;

FIG. 5 is a partial perspective view of the boom of the sail craft;

FIG. 6 is another partial perspective view of the support structure;

FIG. 7 is a front view of a ring portion of the support structure;

FIG. 8 is a side view of the ring;

FIG. 9 is a partial cross-section of the sail craft of the present invention;

FIG. 10 is a schematic representation of the sail craft at a zero degree angle of inclination to the sun;

FIG. 11 is a schematic representation of the sail craft at a non-zero angle of inclination;

FIG. 12 is a plan view of a yaw tab of the sail craft;

FIG. 13 is a schematic representation of the sail craft with a payload in a secured position;

FIG. 14 is a schematic representation of the sail craft with a payload in a transport position;

FIG. 15 is an exploded perspective view of the space craft of the present invention;

FIG. 16 is a partial cross-section of the deployment and separation structure of the carrier craft of the present invention;

FIG. 17 is perspective view of the space craft with the sail craft cover jettisoned; and

FIG. 18 is a schematic representation of the flight of the space craft of the present invention.

### DETAILED DESCRIPTION OF THE PREFERRED EMBODIMENT

The space craft of the present invention is launched from earth and transported into earth orbit as a secondary payload on a traditional chemically fueled rocket. The space craft includes a carrier craft and a sail craft. The carrier craft also serves other mission functions including the capture and transmittal to earth of images, at a minimum, of the deployment of the sail craft. The sail craft separates from the carrier craft, deploys, and uses solar sail technology to accelerate its velocity through the solar system. If the carrier craft contains a rocket motor to propel the space craft out of its initial orbit, the deployed sailcraft may then proceed to accelerate itself out of the solar system.

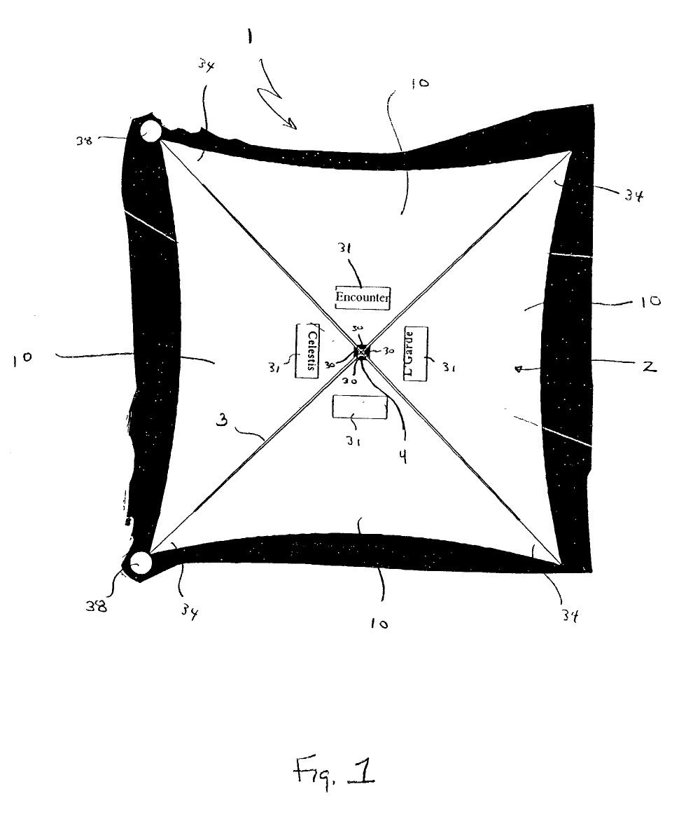

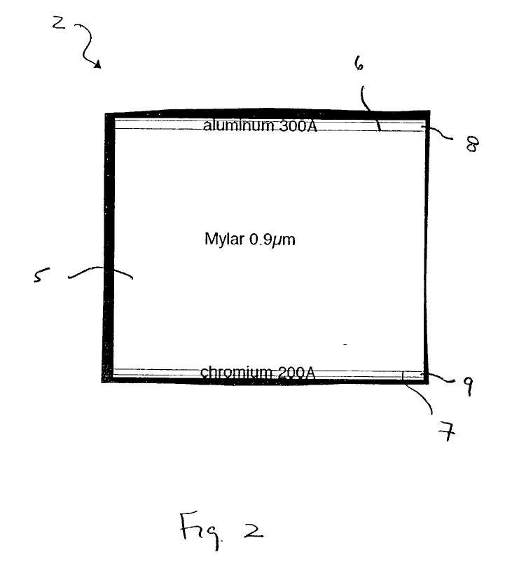

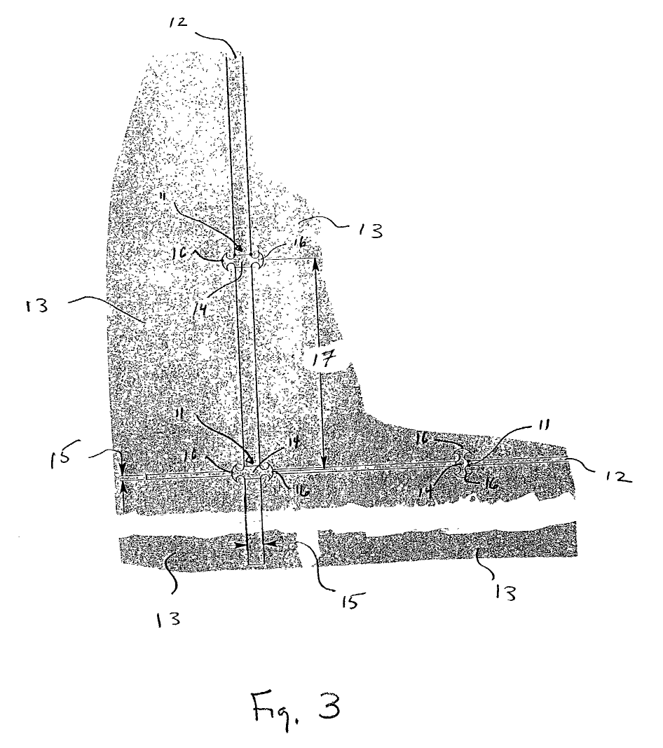

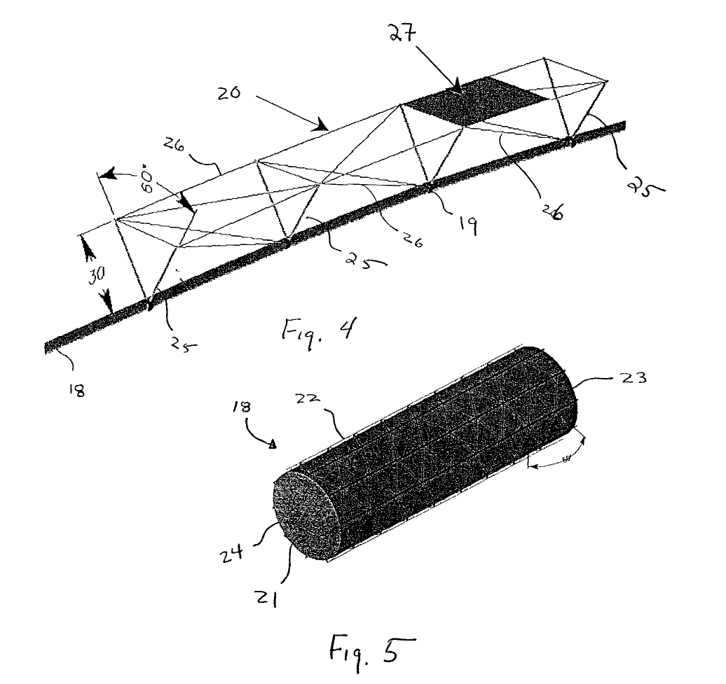

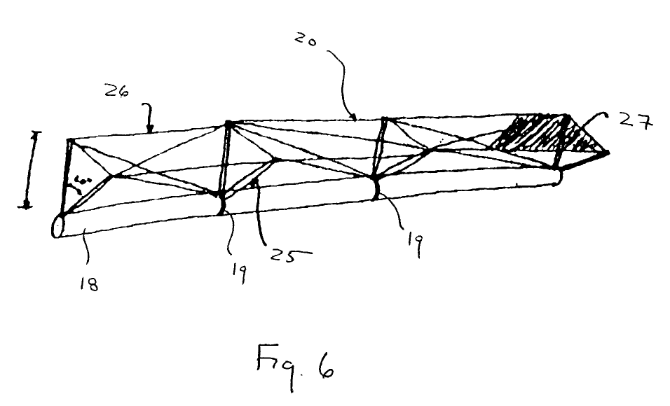

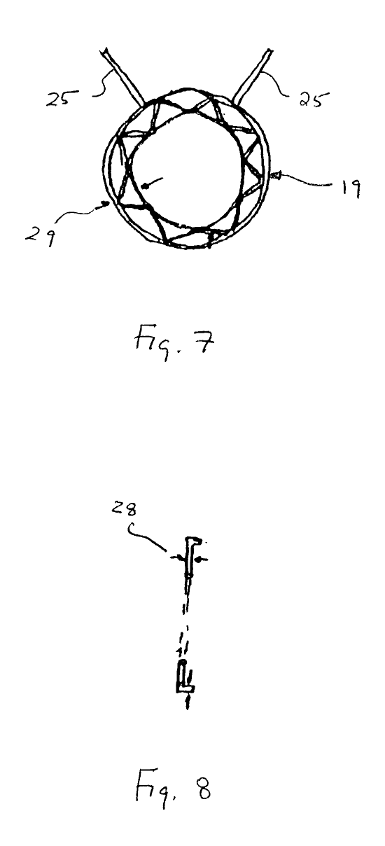

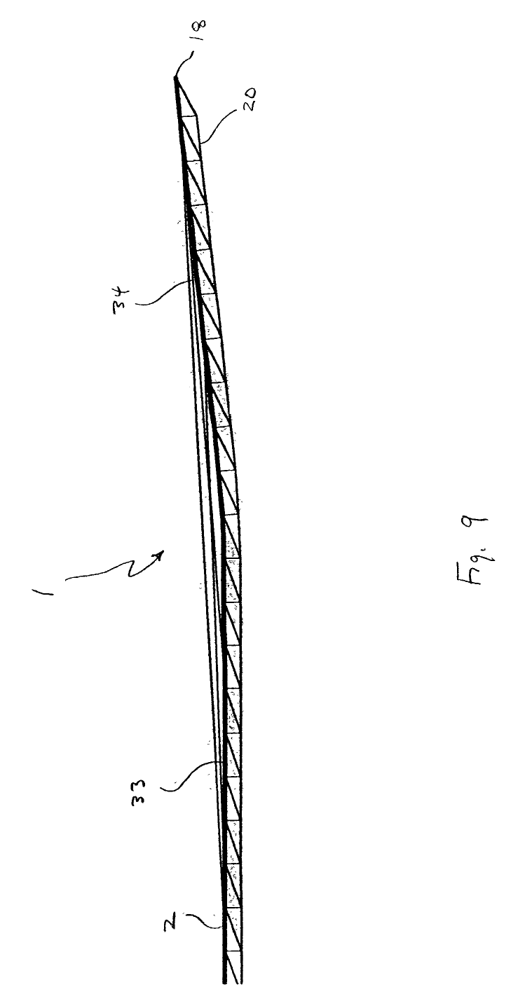

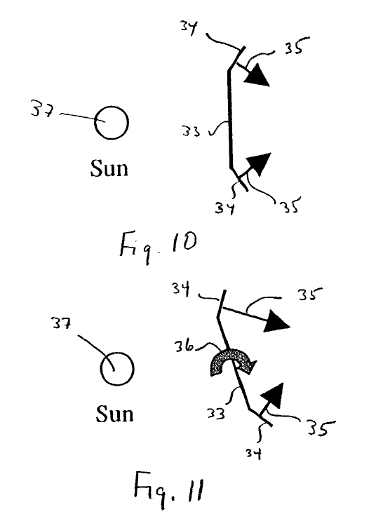

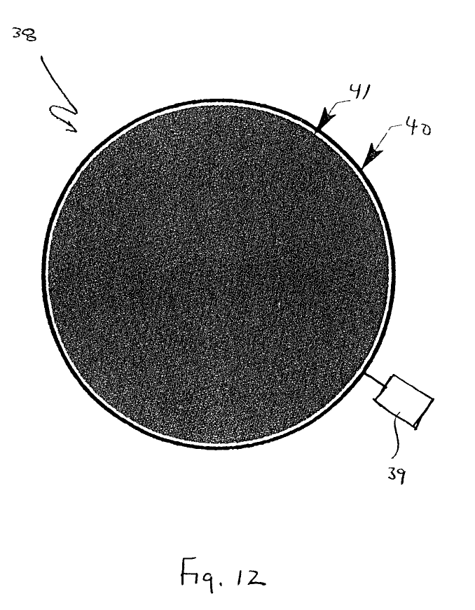

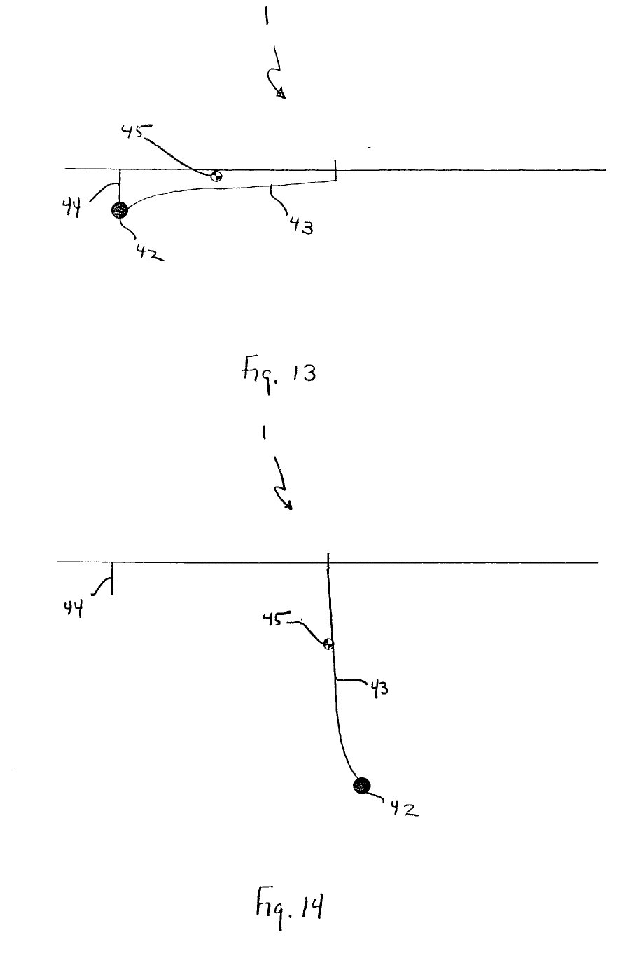

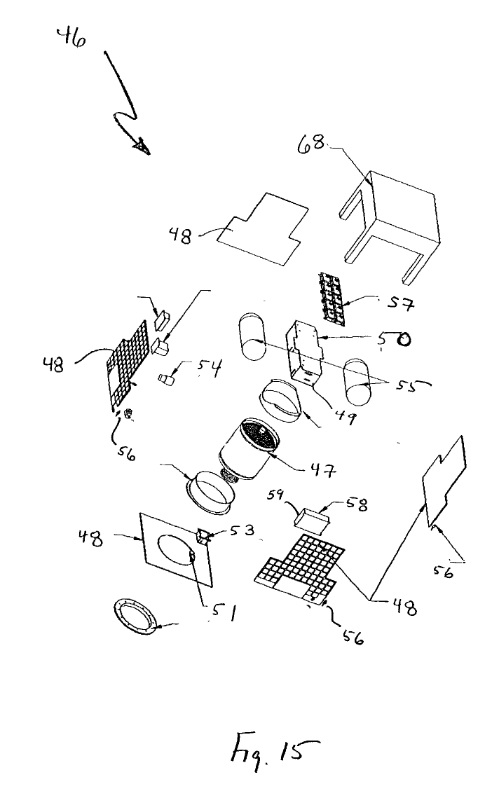

Referring initially to FIG. 1, the sail craft 1 of the present invention is capable of heliocentric, interplanetary, and potentially interstellar space travel. Space travel also includes interplanetary travel, interstellar travel, earth orbit including transfer orbits and non-Keplarian orbits, and heliocentric orbits. The sail craft includes a sail 2, an extensible and rigidizable support structure 3 attached to the sail, and a power array 4 attached to the support structure to provide power and control to the sail craft.

The sail is the large flat portion of the sail craft. The sail is capable of propelling the sail craft by reflecting photons from the Sun. The sail includes a substrate 5 having a front 6 and a back 7 opposite the front, a first reflective metal layer on the front 8, and a second metal layer 9 on the back. Suitable materials for the substrate include polyester films, which are available, for example, under the brand name Mylar® from Dupont Teijin Films of Wilmington, Del. The substrate has a thickness of about 0.91 μm up to about 1.5 μm. Overall, the material of the sail has a radial lightness of about 0.42, a reflectivity of about 90% and a propulsive reflectivity of about 78%. Propulsive reflectivity is a measure of specularity which is a measure of how closely an object looks like a mirror. The operational temperature of the sail is about −38C. In one embodiment, the sail is of sufficient size to propel the sail craft at a velocity of 12.5 km/s. In another embodiment, the sail has an area of up to about 4900 m² and a mass up to about 20 kg.

The front of the sail during space travel faces the Sun; therefore, the first metal layer is selected to provide the highest degree of reflectivity possible with the least amount of weight. Suitable materials include aluminum and silver. Preferably, the first metal layer is aluminum since silver, although a more reflective material, is significantly heavier than aluminum. The second metal layer on the back of the sail is chosen so as to inhibit the sail material from curling and to provide suitable thermal conductivity for the sail material. Suitable metals for the second layer include chromium. The second metal layer also prevents the sail material catching against itself during deployment. The thickness of the first and second metal layers can each be about 100 angstroms up to about 400 angstroms. Preferably, the first metal layer has a thickness of about 300 angstroms, and the second metal layer has a thickness of about 200 angstroms.

Various configurations and shapes of the sail are possible. Suitable shapes for the sail include circles, rectangles and squares. In one embodiment, the sail is square and measures about 30 m by about 30 m. In another embodiment, the sail is square and measures about 76 m by about 76 m. This embodiment is preferred for solar system escape missions or interstellar travel missions where it is desired to accelerate to escape velocity within 2 years from launch. In addition, the sail can be constructed as a single sheet of material or as a combination of a plurality of component sails. Preferably, the sail is constructed of four separate quadrants 10. Each quadrant is preferably triangular in shape.

In order to manufacture the sail, either as a single sheet or as the quadrants, a plurality of sheets of the sail material that are from about 0.3 meters wide up to about 1 meter wide are used. Preferably, the sail is manufactured from a plurality of sheets of sail material that is about 1 meter wide. Using wider material minimizes the number of seams in the finished sail. Since seams lower the propulsive reflectivity of the sail and increase the mass of the sail, it is desirable to minimize the number of seams. The seams are constructed to be as narrow and thin as possible and include adhesively backed seam tapes that can be made out of the sail material. Typically, the seams have a thickness of about 0.2 cm up to about 0.8 cm.

Although the sail material is strong and durable, the material is thin, 120 times thinner than paper, and can easily tear. A particular concern are rips that propagate along the plurality of seams in the sail material. As is best shown in FIG. 3, in order to prevent the propagation of rips in the sail material, the sail includes a plurality of rip terminators 11. Although the rip terminators can be disposed throughout the sail material, preferably, the rip terminators are disposed at the seams 12 between the sections of sheets of sail material 13. Specifically, the rip terminators have a central section 14 arranged to straddle the seam in one or more locations along each seam. This central section has a thickness corresponding to the seam thickness 15 of about 0.2 to about 0.8 cm. Each rip terminator includes one or more curved sections 16 arranged to stop rips that are propagating in either direction along the seam. The curved sections cause the rip to turn back on itself in a generally spiral fashion, preventing further propagation. The location, number, shape, and other distinguishing qualities of the seams and rip stops can be applied with discretion, considering variables such as mass, aesthetics, and robustness. Typically, the space distance 17 between the rip terminators is about 10 cm.

Also, the quality of the sail material may affect sail performance. Therefore for best results, the user may wish to differentiate between: the virginity of the sail material, including amount of handling, folding, etc.; how new the sail material is; and how the material has been worked. The exact characteristics desired may be chosen so as to maximize sail performance variables such as strength and reflectivity. In one embodiment it has been observed that changes in the handling of a sail material (i.e. has been folded previously) does not highly affect reflectivity, because the same material is being used and the reflection, though perhaps in sometimes differing directions, accomplishes substantially the same result. A potential problem is that significant alterations, such as decreases in the amount of sail material present or big stress wrinkles in the sail material, can adversely affect reflectivity. For example, incident solar rays can bounce two or more times, after first hitting the sail, before finally leaving the sail. This tends to cause a type of absorption which lowers the total reflectivity. In certain embodiments it has been found that such absorption can result in about a 10% loss in the reflectivity that would be otherwise experienced. Experiments performed on some embodiments including an extremely wrinkled sample of the sail material, in which no attempt was made to put any stress on the material. The total reflectivity dropped from about 90% to about 88%.

The sail craft also includes an extensible support structure to deploy the sail from a folded position, used for storage of the sail craft, to an expanded or deployed position wherein the sail can propel the sail craft. The support structure is constructed to be able to hold the sail in the expanded position throughout the duration of the sailcraft flight. Preferably, the support structure is a telescopically deployable structure. As is best shown in FIGS. 4 and 6, the support structure 3 includes a plurality of inflatable and rigidizable booms 18, a plurality of rings 19 attached to the booms and the sail to provide for extension of the sail as the boom inflates, and at least one spreader structure 20 attached to each boom to increase the stiffness of the boom and to protect it thermally.

The sail craft includes a sufficient number of booms to efficiently and safely deploy the sail and to hold the sail in the extended or deployed position. In one embodiment, as is best shown in FIG. 1 for the rectangular sail, the sail craft includes four booms running generally diagonally across the sail from the middle to each corner thereof. Each boom is generally tubular in shape, or generally circular in cross section. Preferably, each boom is tapered from the base to the tip to allow for telescopic packaging and deployment. For example, in one embodiment, the boom has a length of 54 m, a base diameter of about 9.5 cm and a tip diameter of about 3 cm. In order to provide for telescopic packaging and deployment of the boom, the boom is preferably hollow so that all of the boom material between the base and the tip can be packaged within the base diameter.

As is best shown in FIG. 5, in order to provide for extensible and rigidizable deployment of the boom, the boom includes an inflatable metallized bladder 21, a plurality of longerons 22 encasing the inflatable bladder, and a plurality of cross straps 23 connected to the longerons, both of which become rigid below their glass transition temperature (T_{g}). Suitable sub-T_{g} rigidizable materials for the longerons and cross straps are flexible when warm so that the booms can be easily packaged and deployed. Once the material cools, for example in space the temperature can get to approximately −100C, it becomes rigid. In addition to just becoming rigid, the boom material can shrink as it gets colder. In the preferred embodiment, the boom material will not contain a substantial amount of carbon, but will include materials that have low coefficients of thermal expansion. Such materials include polybenzoxazole and aromatic polyamides such as poly para-phenyleneterephthalamide which is available under the brand name KEVLAR® from E.I. du Pont de Nemours and Company of Wilmington, Del. Since the boom material needs to remain flexible during deployment in space, the boom can also include an insulation layer 24 to hold it above the glass transition temperature during deployment. Preferably, the bladder material has a thickness of about 13 μm, and the insulation layer has a thickness of about 6.4 μm. The longerons and cross straps can also contain an outer coating to reduce or minimize friction between material faces during deployment. Preferably, this coating contains MYLAR®.

In order to deploy the boom, the bladder is inflated. Preferably, pressurized gas is used to inflate the bladder. Once the bladder is inflated and rigidized, inflation by pressured gas is no longer required. In addition, it is not necessary to maintain the pressurized gas within the bladder. Therefore, a zero-momentum venting system is preferably provided to vent the pressurized gas into space. Both inflation and venting are accomplished so as to minimize any net forces or disturbances on the sail craft. An additional benefit of the sub-T_{g} rigidizable material of the support structure is that above the glass transition temperature the material will soften to permit reversal of the boom extension, re-packaging and other actions such as in-flight boom building and repair.

In order to provide the necessary stiffness and strength to the boom without imparting too much mass to the sail craft, the bladder is surrounded by an isogrid containing a plurality of longerons 22 running the length of the bladder and a plurality of cross-straps 23 connecting the longerons. Each boom includes about 80 longerons at its base and about 26 longerons at its tip. Each longeron has a thickness of about 0.015 cm. The cross straps represent about 60% of the thickness and width of the longerons. Overall, the longerons and cross straps represent a fill factor of about 9% of the area around the boom. Suitable materials for longerons and cross straps include polybenzoxazole, aromatic polyamides, or CF. The longerons are primarily the load carrying components of the boom and are generally bigger than the cross straps, which are there to stabilize the longerons.

As is best shown in FIGS. 4 & 6, the spreader structure 20 is attached to the boom, preferably on the sun side of the sail. The spreader structure is sufficient to increase the stiffness of the boom to greater than about 2200 N/m², to increase the natural frequency of the boom for purposes of attitude control of the sail craft, and to place the boom in compression. The spreader structure is a catenary type structure having a plurality of tubes 25 and wires 26. The wires are preferably about 0.5 mm in diameter, and the tubes are preferably about 0.6 cm diameter collapsible tubes having 0.25 mm thick walls. Suitable materials for the spreader structure include polybenzoxazole, aromatic polyamides, or CF. The support structure also includes a sunshade 27 attached to the spreader structure to shield the boom from the Sun in order to keep the temperature of the boom below the glass transition temperature so that the boom will remain rigid.

As is best shown in FIGS. 7 and 8, the plurality of rings 19 attach the booms to the spreader structure and the sail to boom to provide for extension of the sail as the boom inflates. Preferably, 42 rings are provided for each boom. Each ring is arranged as a generally circular flange-like ring having a thickness 28 of about 3 mm, a 1 cm flange area 29 having a fill of about 25%. Suitable materials for the rings include polybenzoxazole, aromatic polyamides, or CF. In a preferred embodiment, all of the components of the support structure, the boom, bladder, longerons, cross straps, spreader structure, and rings, are made of the same material so that all of these components will all shrink and expand in the same way.

The spreader structure attached to each boom and sail increases the stiffness of the boom and places the sail in isotensoid stress, which means that the stress is substantially the same in all directions, leaving substantially no sheer stresses, which prevents stress wrinkles in the sail. Wrinkles can cause loss of not just the projected area, but effectively the cosine squared of that area. In the preferred embodiment, the spreader system is only on the sun side of the sail craft because that is the direction in which the forces are applied to the sail craft causing the boom to bend which is resisted by the spreader structure. The increased stiffness also contributes to attitude control of the sail craft by minimizing the natural frequency, which affects the angle of pitch and roll of the sail craft. The plurality of rings are distributed along the length of the boom to spread forces along the boom to prevent creasing of the boom and to spread the attachment forces on the sail along the length of the sail. In addition, the spreader structure places the boom in compression, and the rings distribute this compressive force along the length of the boom instead of concentrating the compression force at the ends of the boom.

The power array 4 for the sail craft of the present invention includes at least one and preferably a plurality of solar panels 30 and at least one power switcher (not shown) electrically coupled to the solar panels to regulate and to direct power to the sail craft. The solar panels can be attached to the sail substrate to provide power to the sail craft. In one embodiment, the power array includes four solar panels, one each attached directly to the four quadrants of the rectangular solar sail. The solar panels are preferably located in the center of the sail. A sufficient number and area of solar panels are needed to provide the required amount of power to the sail craft. Preferably, the power array has about three-square meters of solar panel material to generate the power to run the sail. In this embodiment, the sail can generate 200 watts of power on the first day of deployment of the sail craft at 1 AU. Additional solar arrays can be added to the sail craft as desired.

In order to facilitate public and commercial participation in any space mission involving the sail craft of the present invention, the sail includes at least one main area 31 containing a logo, such as a corporate logo or advertisement. A camera on the carrier craft will capture images of the logo for transmission back to Earth.

Steering of the sail craft is provided by the combined shape of the support structure and sail and through the use of active steering mechanisms. Preferably, the sail craft provides for a combination of active steering and passive steering. Active steering is provided to control the rotation around one axis of a three axis coordinate system. Passive steering is used to provide rotational control around the other two axes of the three axis coordinate system.

As is best shown in FIGS. 9-11, passive steering control of rotation about two axes of the three axis coordinate system is provided by the shape of the sail and support structure. The sail includes a main section 33 and a plurality of tab sections 34 extending from the main section such that forces 35 applied to the sail by electromagnetic radiation from the Sun 37 incident upon the tab sections, as the sail rotates from an initial position (FIG. 10) to a second position (FIG. 11) about the two axes, create a moment force 36 that returns the sail to the initial position. Preferably, the sail includes four of these tab sections, one each along either the sides of the rectangular sail or at the corners of the rectangular sail. Preferably, the tab sections are formed by bending the tips of the booms so that the desired stability is achieved. This type of passive steering and stability is similar in theory to the type of control provided to an airplane by its tail. The solar force pushes against the tab sections, as wind does in airplane control, and if the sail rotates about one of the two axis, then one or more of the tab sections side will become effectively larger from the sun's perspective. The resulting forces will cause moments that will cause the sail to rotate in the opposite direction.

As is best shown in FIGS. 1 and 12, active steering or rotational control about the third axis of the three axis coordinate system is provided by a yaw control system attached to the sail craft and electrically coupled to the power array. In one embodiment, the yaw control system includes at least one positionable yaw tab 38 to control rotation of the sail craft about the one axis, at least one yaw tab actuator 39 for each yaw tab to control the position of the yaw tab, and a yaw sensor to measure the rotational position of the sail craft about the one axis. Preferably, the yaw control system includes two yaw tabs. In one embodiment, the yaw tabs are located at the corners of the rectangular sail. Preferably, the yaw tabs are located at opposing corners (FIG. 1). The yaw tabs are preferably shaped as an isogrid torus, the outer circle 40 of which is an inflatable tube arranged as an extension from the bladder and having a diameter of about 5 cm. The center portion 41 of the yaw tab has a diameter of about 4 m and is constructed of the same material as the sail. This arrangement provides for thermally rigidizable yaw tabs than can be stored in the boom prior to deployment. In another embodiment, the yaw control system varies the center of mass position relative the sail craft center of pressure by pivoting a mass on a gimbal.

The yaw control system of the present invention minimizes mass, complexity, and cost of the sail craft. Providing positive, or active, control at all three axes is difficult. Three-axis passive stability is not preferred for travel around the sun line, the line between the sun and the sail, which is totally symmetric, because there would be no reference point for the sail to passively steer itself. This would not matter for travel in a normal, or radial, position, straight away from the sun, but if inclined, the craft would generally pinwheel around so that any accomplished positive thrust may also work negatively, to decelerate the sail craft, when the craft turns around and add mechanical loads to the structure from the imposed centrifugal forces. If the sail craft is flying radially, or straight away from the sun, active control through the yaw control system is no longer required. The sail craft simply spins around the one axis, and rotations around the other two axes will continue to be controlled by the tab portions of the sail.

The yaw control system will contain at least one yaw sensor. In one embodiment, this sensor may be a star camera to determine sail craft relative yaw motion and provide a corrective signal to the yaw controller to zero the motion.

Preferably, the yaw tab actuator is a high output rotary actuator. In one embodiment, the actuator can be approximately 10 cm by 1.5 cm, and thus can slip down inside the end of the booms. In this embodiment, the actuator is stored in the boom and then deploys out and then rotates 0 to 60 degrees to contribute to the desired yaw control.

Referring to FIGS. 13 and 14, the sail craft also includes a payload 42 moveable from a secured position (FIG. 13) to a transport position (FIG. 14). The payload 42 is secured to the sail craft by an attachment mechanism. In one embodiment, the attachment mechanism is a tether 43. A releasable latching mechanism 44 is used to hold the payload in the secured position for launch. The payload can include scientific research materials, messages, or other artifacts. The latching mechanism is electrically coupled to the power array. Preferably, the latching mechanism is a burn wire. In one embodiment, the tether includes a spring. By shifting the payload, the weight of the payload contributes to the steering of the sail craft by changing the center of mass 45 of the sail craft. In another embodiment, the tether is repaired by rigid structure, and the payload is gimbaled to contribute to the steering of the sailcraft.

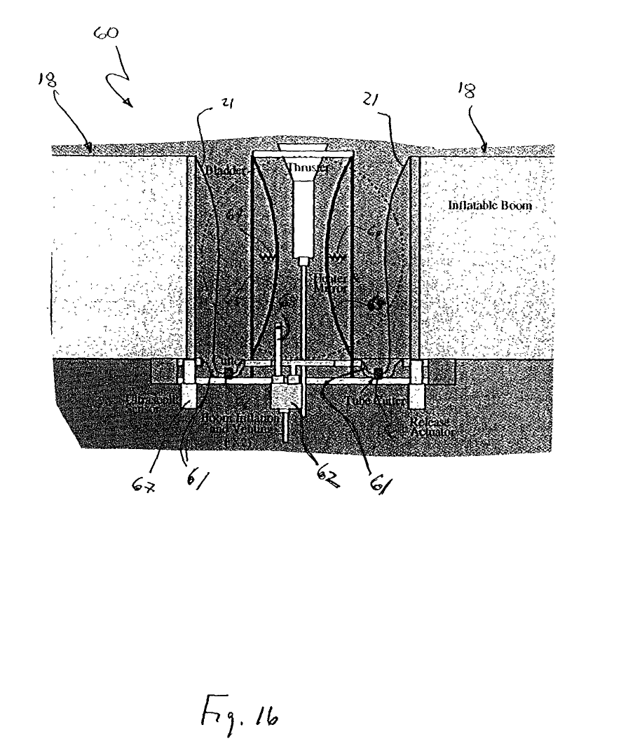

As is best illustrated in FIG. 15, the carrier craft is releasably attached to the sail craft to inflate the booms and expand the sail, and to deploy the sail craft. The carrier craft 46 includes a power source and control system and may also include a rocket motor 47 capable of providing a sufficient amount of a change in velocity to transfer the space craft out of earth orbit after launch. The power source and control system includes a plurality of solar panels 48, at least one battery 49, and an expandable space craft kernel 50 comprising hardwired digital electronics.

The carrier craft also includes an attitude control and determination system electrically coupled to the power source and control. The attitude determination and control system includes at least one sun sensor 51, at least one star camera 53, and at least one initializable inertial sensor 54. In addition, the attitude control and determination includes at least one or alternatively at least two pressurized, cold gas tanks 55 and a plurality of gas thrusters 56 coupled to the cold gas tank to apply directing forces to the space craft.

The carrier craft further includes a communications system to transmit data and images from the space craft to earth. The communications system includes at least one imaging camera 57. In order to transmit images captured by the camera to the Earth, the communications system includes at least one RF transponder 58 and at least one RF antenna 59. An image compression system is utilized by the communications system for more efficient image storage and downlink.

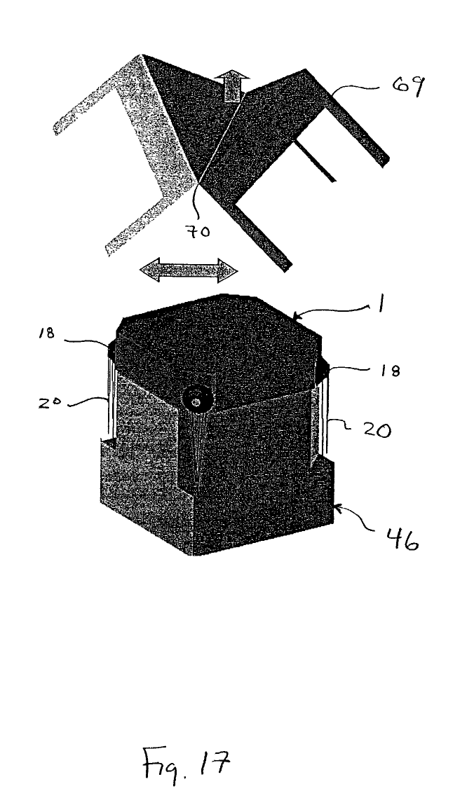

As is best shown in FIG. 16, in order to deploy the sail craft and to separate the sail craft from the carrier craft, the space craft includes a sail craft deployment and separation structure 60. The deployment and separation structure includes tubing 61 and regulators 62 to direct the pressurized gas from the gas tanks into the bladders to inflate the booms and a plurality of vents 63 to off-gas the pressurized gas. These vents are arranged so as impart a zero net force on the sail craft during off-gassing. The deployment and separation structure also includes a plurality of heat lamps 64 to heat the bladders during inflation. Mirrors 65 are provided to direct the radiation from the heat lamps into the bladders. The separation mechanism is arranged to separate the sail craft from the carrier craft without inducing any net forces on the sail craft. Preferably, the separation mechanism includes a plurality of tubing cutters 66 to sever the bladder inflation lines and to allow the carrier craft to separate and drift away from the sail craft.

In order to monitor the inflation of the bladders inside each boom, the deployment and separation structure includes a sensor 67 to determine how far the boom is deployed.

As is best shown in FIGS. 15 and 17, during launch and initial spaceflight, the sail craft is packaged and stored on the carrier craft so as to minimize the amount of space occupied and to provide for a structure that is readily and easily deployable. In a preferred embodiment the packaged sail craft has a table-like shell 68 shape and is protected or held in place by a similarly shaped cover 69. During deployment, the cover is initially jettisoned (FIG. 17). In order to facilitate removal of the cover, the cover can include structures, for example piano-type hinges 70 along a diagonal so that the cover breaks away from the packaged sail craft without touching it or rubbing. After removal of the cover, the spreader structure is allowed to initially expand by removing a tie wire that was holding the spreader structure 20 in a compact position. The booms 18 are then extensibly deployed. In the preferred embodiment, the sail is rectangular and the booms run diagonally across the sail. The sail is folded so as to facilitate this deployment.

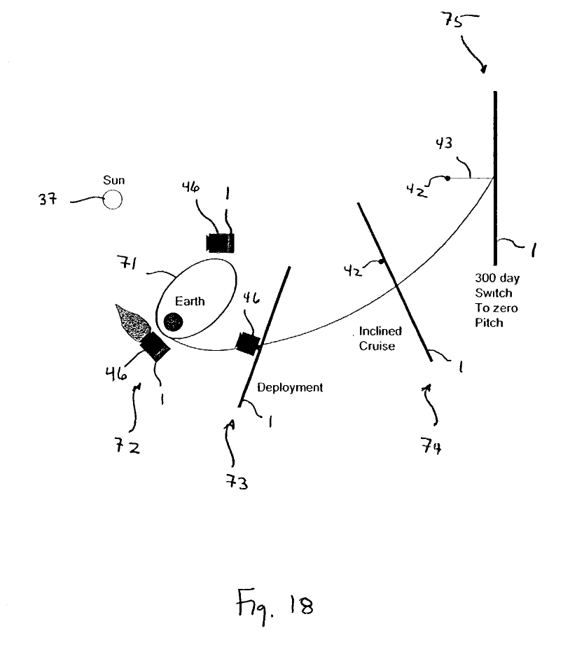

Referring to FIG. 18, the space craft of the present invention is suitable for interstellar space travel. In order to use the space craft in interstellar space travel, the space craft of the present invention is launched into a transfer orbit 71, preferably as a secondary payload aboard a conventional rocket. While in orbit, the space craft systems are tested, including rehearsing the capture and transmission of images. The space craft escapes transfer orbit at perigee 72, by firing the solid fuel rocket of the carrier craft 46. Once the rocket has fired to take the space craft out of earth orbit, the space craft will coast, transporting the space craft above all of the significant parts of the Earth's atmosphere. Once out of orbit, the sail craft is deployed 73 and is released or separated from the carrier craft. The deployed and released sail craft then accelerates to at least solar escape velocity and leaves the solar system and continues in interstellar flight.

In order to keep the size and weight of the space craft as low as possible and to minimize the complexity of the controls aboard the space craft, the operation of the space craft is controlled from Earth, using a network of Earth based control centers.

In order to accelerate the sail craft to the necessary velocity, two alignments of the sail with respect to the sun are possible, a normal sail and an inclined sail. A normal sail is oriented such that its facing directly at the sun, and all the resultant thrust from the electromagnetic radiation is directed away from the sun. However, the sail craft is orbiting the sun and has a component of velocity that is directed around the sun as opposed to away from the sun. So, the solar sail is generating thrust in a direction that it is not traveling and is traveling in a direction in which it is producing no thrust. Therefore, by inclining the sail with respect to the sun, a component of thrust is created in the direction of travel, i.e., around the sun, and adequate acceleration of the sail is achieved with a sail having a mass that is more reasonable to actually achieve with current technology.

In the preferred embodiment, the position of the sail craft with respect to the sun is varied. Initially, the sail craft is inclined 74 with respect to the sun, called tacking. During the first days of the mission, the sail craft is operated at an angle to the sun, contributing needed thrust and acceleration to the sail craft. After the initial period, the speed of the sail craft is large enough that additional tangential thrust from tacking is no longer required. Because tangential thrust is not needed, the sail craft is changed to a zero degree angle with respect to the sun. Thereafter, all of the trust is radially away from the sun and all attitude controls on the sail craft are passive. The sail craft then continues to accelerate out of the solar system.

The sail should be able to produce thrust for the sail craft for a period of time of at least about 10 years. Once the sail craft has moved beyond the solar system, it will continue under its own momentum, and virtually no forces will be acting on the sail craft. Although the sail craft may experience degradation and deterioration due to environmental affects such as radiation, the mission will not be negatively affected, because the sail craft already has and will maintain its escape velocity. The mass of objects that is the sail craft will continue to travel together as a group indefinitely or until it interacts with another star or gravitational body.

While the present invention has been described and illustrated herein with respect to the preferred embodiments, it should be apparent that various modifications, adaptations, and variations may be made utilizing the teachings of the present disclosure without departing from the scope of the invention and are intended to be within the scope of the present invention.

What is claimed is:

1. A sail craft capable of space travel, the sail craft comprising:
a sail having a folded position and an expanded position, the sail capable of propelling the sail craft by reflecting photons;
an extensible and rigidizable support structure attached to the sail to deploy the sail from the folded position to the expanded position and to hold the sail in the expanded position; and
a power array attached to the support structure to provide power and control to the sail craft.

2. The sail craft of claim 1, wherein the sail comprises:
a substrate comprising a front and a back opposite the front;
a first reflective metal layer on the front; and
a second metal layer on the back.

3. The sail craft of claim 2, wherein the substrate has a thickness of about 0.9 μm.

4. The sail craft of claim 1, wherein the sail is of sufficient size to propel the sail craft at a velocity of 12.5 km/s.

5. The sail craft of claim 1, wherein the sail has an area of 4,900 m² and has a mass of about 20 kg.

6. The sail craft of claim 1, wherein the sail comprises a plurality of rip terminators.

7. The sail craft of claim 6, wherein:
the sail comprises a plurality of sheets joined at a plurality of seams; and
the rip terminators are disposed at the seams.

8. The sail craft of claim 2, further comprising at least one solar panel attached directly to the sail substrate to provide power to the sail craft.

9. The sail craft of claim 8, wherein:
the sail further comprises four separate quadrants; and
the sail craft comprises at least four solar panels, one attached to each of the four quadrants.

10. The sail craft of claim 1, wherein the sail comprises at least one area containing logos.

11. The sail craft of claim 1, wherein the sail is shaped to provide passive rotational steering control about two axes of a three axes coordinate system.

12. The sail craft of claim 11, wherein the sail further comprises:
a main section; and
a plurality of tab sections extending from the main section such that forces applied to the sail by photons incident upon the sections as the sail rotates from an initial position about the two axes return the sail to the initial position.

13. The sail craft of claim 1, wherein the support structure comprises:
a plurality of inflatable and rigidizable booms;
a plurality of rings attached to the booms and the sail to provide for extension of the sail as the boom inflates; and
at least one spreader structure attached to each boom to increase the stiffness of the boom.

14. The sail craft of claim 13, wherein the boom further comprises:
an inflatable bladder;
a plurality of longerons encasing the inflatable bladder; and
a plurality of cross straps connected to the longerons.
wherein the longerons and cross straps are comprised of a material that becomes rigid below its glass transition temperature.

15. The sail craft of claim 14, wherein the longerons and cross straps further comprise an outer coating to reduce friction during deployment.

16. The sail craft of claim 14, wherein the longerons and the cross straps further comprise polybenzoxazole, an aromatic polyamide, or CF.

17. The sail craft of claim 14, wherein the boom further comprises an insulation layer to hold the inflatable boom above the glass transition temperature during inflation.

18. The sail craft of claim 14, wherein the support structure further comprises a sunshade attach to the spreader structure to shield the boom from the sun and to keep the temperature of the boom below the glass transition temperature.

19. The sail craft of claim 14, wherein pressurized gas is used to inflate the bladder, and the bladder further comprises a plurality of vents to off-gas the pressurized gas, the vents disposed about the bladder so as impart a zero net force on the sail craft during off-gassing.

20. The sail craft of claim 1, wherein the power array comprises:
a plurality of solar panels; and
at least one power switcher electrically coupled to the solar panels to regulate and to direct power to the sail craft.

21. The sail craft of claim 1, further comprising:
a payload moveable from a secured position to a transport position;
an attachment mechanism to attach the payload to the sail craft; and
a releasable latching mechanism to hold the payload in the secured position.

22. The sail craft of claim 21, wherein the latching mechanism is electrically coupled to the power array.

23. The sail craft of claim 1, further comprising a yaw control system attached to the sail craft and electrically coupled to the power array to provide active rotational steering about one axis of a three axis coordinate system.

24. The sail craft of claim 23, wherein the yaw control system comprises:
at least one positionable yaw tab to control rotation of the sail craft about the one axis;
at least one yaw tab actuator for each yaw tab to control the position of the yaw tab; and
a yaw sensor to measure the rotational position of the sail craft about the one axis.

25. The sail craft of claim 24, further comprising at least two yaw tabs.

26. The sail craft of claim 24, wherein the sail is shaped to provide passive rotational steering about two axes of the three axis coordinate system.

27. A space craft comprising:
a sail craft capable of interstellar space travel, the sail craft comprising:
a sail having a folded position and an expanded position, the sail capable of propelling the sail craft by reflecting electromagnetic radiation; and
an extensible and rigidizable support structure attached to the sail to deploy the sail from the folded position to the expanded position upon extension and to hold the sail in the expanded position; and
a carrier craft releasably attached to the sail craft and capable of transporting the space craft out of orbit around the earth, the carrier craft comprising:
a power source and control system; and
a rocket motor capable of providing a sufficient amount of a change in velocity to transfer the space craft out of orbit around the earth.

28. The space craft of claim 27, wherein the power source and control system comprises:
a plurality of solar panels;
at least one battery; and
an expandable space craft kernel comprising hardwired digital electronics.

29. The space craft of claim 27, further comprising an attitude control and determination system electrically coupled to the power source and control system, the attitude determination and control system comprising:
at least one sun sensor;
at least one star camera;
at least one initializable inertial sensor; and
a horizon sensor

30. The space craft of claim 29, wherein the attitude control and determination system further comprises:
at least one pressurized, cold gas tank; and
a plurality of gas thrusters coupled to the cold gas tank to apply directing forces to the space craft.

31. The space craft of claim 27, further comprising a communications system to transmit data and images from the space craft to earth.

32. The space craft of claim 31, wherein the communications system comprises:
at least one RF transponder; and
at least one RF antenna.

33. The space craft of claim 27, further comprising a sail craft deployment and separation structure to extend the support structure and to separate the sail craft from the carrier craft.

34. The space craft of claim 27, wherein:
the carrier craft further comprises at least one pressurized cold gas tank;
the support structure comprises a plurality of inflatable bladders; and
the deployment and separation structure comprises:
tubing and regulators to direct the gas into the bladders; and
a plurality of vents to off-gas the pressurized gas, the vents arranged so as impart a zero net force on the sail craft during off-gassing.

35. The space craft of claim 34, wherein the deployment and separation structure further comprises:
a plurality of heat lamps to heat the bladders during inflation; and
a plurality of ultrasonic sensors to monitor the percentage of inflation of the bladders.

36. The space craft of claim 33, further comprising a separation mechanism to separate the sail craft from the carrier craft without inducing any net forces on the sail craft.

37. A method for interstellar space travel comprising:
launching a space craft comprising a carrier craft and a sail craft into earth transfer orbit;
escaping earth transfer orbit at perigee;
deploying the sail craft;
releasing the sail craft from the carrier craft; and
accelerating the sail craft to solar escape velocity.

38. The method of claim 37, wherein the step of deploying the sail craft comprises expanding a solar sail using a plurality of extensible support structures attached to the solar sail.

39. The method of claim 38, wherein the support structures include inflatable bladders and the step of expanding the solar sail comprises inflating the bladders.

40. The method of claim 38, wherein the step of deploying further comprises:
imaging the expanding solar sail using a plurality of cameras; and
transmitting the images to earth.

41. The method of claim 37 further comprising controlling the space craft from the earth.

42. The method of claim 37, wherein the step of accelerating the sail craft comprises:
positioning the sail craft at an angle to the sun; and
switching the sail craft to a zero angle of inclination.
